(19) United States
(12) Patent Application Publication
(10) Pub. No.: US 2012/0311626 A1
(43) Pub. Date: Dec. 6, 2012

(54) DISTRIBUTING APPARATUS FOR CONTENT LIST AND CONTENT, AND TRANSMITTING METHOD

(75) Inventors: Shimpei USUI, Yokohama (JP); Takaki Matsushita, Yokohama (JP); Chiyo Ohno, Chigasaki (JP)

(73) Assignees: Hitachi Consumer Electronics Co., Ltd.; Hitachi-LG Data Storage, Inc.

(21) Appl. No.: 13/487,487

(22) Filed: Jun. 4, 2012

(30) Foreign Application Priority Data
Jun. 6, 2011 (JP) 2011-125937

(51) Int. Cl. H04N 21/2347

(52) U.S. Cl. 725/31

(57) ABSTRACT

A distributing apparatus including a communication processor unit to execute transmission of data between a content receiving apparatus connected through a network; a content list producer unit to produce an optical disc content list for when loaded in the optical disc drive apparatus, while to produce a recording medium content list when the optical disc is not loaded; a content list transmitter unit; a content transmitter unit; an authenticator unit; a key producer unit, which is configured to produce key information necessary for encoding the content(s) to be transmitted by the content transmitter unit; and an encoder unit, which is configured to encode the content(s) with using the key information in the key producer unit.

This application relates to and claims priority from Japanese Patent Application No. 2011-125937 filed on Jun. 6, 2011, the entire disclosure of which is incorporated herein by reference.

### BACKGROUND OF THE INVENTION

The present invention relates to a distributing apparatus for a content list and content(s), and a transmitting method.

Accompanying with development of digital video signal processing technology, various products of digital AV apparatuses appear on the market one after another, such as, a digital tuner for receiving digital broadcasts, a television apparatus building that digital tuner therein (hereinafter, being called “DTV”), a digital recording apparatus for recording/reproducing digital broadcast programs (for example, a HDD recorder or a DVD (Digital Versatile Disc) recorder, a BD (Blu-ray Disc) recorder, and a NAS (Network Attached Storage), etc.

Also, because of spreading or popularization of the broadband/Internet, it becomes possible to transmit digital content(s) inside/outside a home through a network, with using those PC and the digital AV apparatuses, installing a wired/wireless LAN (Local Area Network), IEEE1394, USB (Universal Serial Bus), HDMI (High Definition Multimedia Interface), etc. In particular, as a guide line for sharing the digital content(s) commonly with using a network built within a home, DLNA (Digital. Living Network Alliance) spreads widely. At present, on the market appear a large number of AV apparatuses enabling with the DLNA, including a PC therein, for sale.

When transmitting the digital content(s) between the digital AV apparatuses, a copy protection is conducted thereon for preventing from production of limitless copying thereof, by executing an encoding on the side of a content transmitting apparatus and sharing the information for decoding between the content receiving apparatus side, so that the content(s) will not be received and decoded, correctly, on equipment other than the content receiving apparatus locating at a destination of transmission.

As an example of such copy protection method, which is applied in the digital AV equipment, there is a method described in the following Patent Document 1, for example. According to the method described in the Patent Document 1, the contents are classified into “Copy free”, “Copy free with EPN asserted”, “Copy one generation”, “No more copies” and “Copy never”, for management thereof, while the recording apparatus records only the contents of the “Copy free”, the “Copy free with EPN asserted” and the “Copy one generation”, but it treats the contents of the “Copy one generation” as that of “No more copies” after recording once and transmits them by treating an encoding process on the transmitting side excepting for the contents of the “Copy free” on the network/bus; thereby protecting the content(s) from being copied limitlessly.

In the following Patent Document 2 is disclosed a technology for increasing the copyright protection of content(s), when transmitting content(s) between equipment. On the other hand, video/audio content(s), such as, movies and music, etc., are recorded on an optical disc, such as, the BD, DVD, CD (Compact Disc), etc., and are distributed on the market, widely. When the content(s), the copyright of which should be protected, is recorded on the optical disc, the following DRM (Digital Rights Management) technologies are applied; such as, AACS (Advanced Access Content System), CSS (Content Scramble System) and CPRM (Content Protection Recordable Medium), as the copy protection technology.

In the following Patent Document 3 is disclosed a technology for enabling to reproduce a play list of a removable medium, on which the recording is made outside a network, upon remote viewing/listening within said network. When a DVD is loaded into an information processing apparatus, content items to be reproduced from a top to an end in accordance with PGC (Program Chain) of material contents accumulated on the DVD are registered in a content directory.

Further, when the play list is recorded on the DVD loaded, the content items corresponding to imaginary contents are registered in the content directory, so as to reproduce the material contents in the order of reproduction, which is designated by that play list.

### PRIOR ART DOCUMENTS

### Patent Documents

[Patent Document 1] Japanese Patent Laying-Open No. 2005-269288 (2005);
[Patent Document 2] Japanese Patent Laying-Open No. 2010-119137 (2010); and
[Patent Document 3] Japanese Patent Laying-Open No. 2008-41120 (2008).

### BRIEF SUMMARY OF THE INVENTION

Under a circumstance of connecting a content distributing apparatus, building therein an optical disc drive for dealing with BD, DVD, etc., or a removable medium other than that, or mounting it detachably, to be usable, and a reproducing apparatus for reproducing the content(s), such as, TV and/or PC, etc., via the network, it is assumed that the content distributing apparatus transmits the content(s) within the recording medium, such as, an optical disc, to at least one (1) or more number(s) of the reproducing apparatus(es) through a communication path, such as, the network, etc., thereby to enable that content(s) to be viewed/listened on the reproducing apparatus.

For example, with the DLNA, since reproduction of the content(s) is conducted by a unit of a file, in particular, when reproducing the content(s) of the BD or the DVD with using the DLNA, it is impossible to provide a user interface, which is provided on a general reproducing apparatus, such as, a BD/DVD player, etc. Because of this, there is also a case where reproduction of the content(s) cannot be made. Also, with the conventional content list distributing apparatus, since it does not produce a content list, distinguishing for each of that recording medium, under the circumstance according to the DLNA, there is a problem to be dissolved that a user cannot search the content(s) at her/his desire, depending on the content(s).

When reproducing the content(s) with using the DLNA, the reproducing apparatus produces the user interface to be displayed on a screen of the reproducing apparatus; however, when an ordinary BD/HDD recorder, being popular on the market, reproduces the content(s) held on HDD or BD, which is connected inside, since the recorder produces the user interface by itself, it can produce a user interface, separating between HDD content(s) and BD content(s), in advance. Therefore, there is no chance that such problem as was mentioned above occurs, in the case of the recorder.

Then, an object according to the present invention is to conduct the content distribution for achieving the user interface corresponding to the BD/DVD player through the DLNA, for BD and/or DVD, only by enabling the DMS, but without changing the structure of the existing DMP.

The object according to the present invention can be achieved by provision of the content list contributing to usability by a user, for example, in the distributing apparatus of content(s).

According to the present invention, it is possible to provide a user interface being superior in the usability thereof, in the distribution of content(s) within an optical disc of the content list and the distributing apparatus of content(s).

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an outlook view for showing an embodiment of the present invention;

FIG. 2 is a system configuration view for showing the embodiment of the present invention;

FIG. 3 is a flowchart for showing the embodiment of a distributing apparatus of a content list and content(s);

FIG. 4 is a flowchart for showing the embodiment of the distributing apparatus of a content list and content(s);

FIG. 5 is a view of an example of a screen display for showing the embodiment of a distributing apparatus of a content list and content(s);

FIG. 6 is a flowchart for showing the embodiment of a distributing apparatus of a content list and content(s);

FIG. 7 is a structure view for showing the embodiment of a distributing apparatus of a content list and content(s);

FIG. 8 is a structure view for showing the embodiment of a distributing apparatus of a content list and content(s); and

FIG. 9 shows an example of a user interface to be displayed on a reproducing apparatus.

### DETAILED DESCRIPTION OF THE PREFERRED EMBODIMENTS

Hereinafter, explanation will be made on embodiments according to the present invention.

The present embodiment is an example, in which a content receiving apparatus, such as, a TV or a PC displays content(s), which is/are transmitted from a distributing apparatus for a content list and content(s) through a network, to be viewed/listened.

However, herein after, when being described as “a content distributing apparatus”, that apparatus includes a content list as an object to be distributed (or transmitted) thereby, if there is no such description.

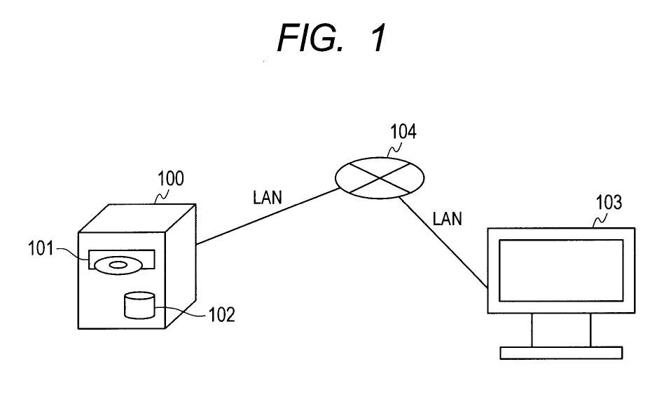

FIG. 1 shows a total image of the present embodiment.

A content distributing apparatus 100 comprises an optical disc drive 101 and a built-in recording medium 102, and it is able to communicate with a TV 13, which is a content receiving apparatus.

The content distributing apparatus 100 distributes the content(s) accumulated on an optical disc, which is loaded within the optical disc drive 101, and on the built-in recording medium 102, through a network to the content receiving apparatus. On the other hand, the content receiving apparatus 103 is information equipment for requests reproduction content(s) to the content distributing apparatus 100, and for reproducing the content(s) received from the content distributing apparatus 100.

On the LAN, a standard IP (Internet Protocol) is applied as a network protocol, and TCP (Transmission Control Protocol) and UDP (User Datagram Protocol) are applied as a higher-ranked transport protocol. For transmission of the content(s) is applied a further higher-ranked application protocol, such as, RTP (Real-time Transport Protocol), HTTP (Hyper Text Transfer Protocol, or FTP (File Transfer Protocol), etc., for example.

However, there are known IPv4 and IPv6 differing in the version thereof as IP, but the present invention should not be limited only to either one of them. Also, not shown in the figure, but each apparatus may be connected via a hub or a router by means of the LAN.

The content distributing apparatus 100 transmits the content(s) within the optical disc, which is loaded into the optical disc drive 101, to the content receiving apparatus 103, being connected with through the network. When the content(s) to be transmitted be that, the copyright of which should be protected, DTCP-IP (Digital Transmission Content Protection over Internet Protocol) is applied, for protecting them from illegal copying or alternation on the network.

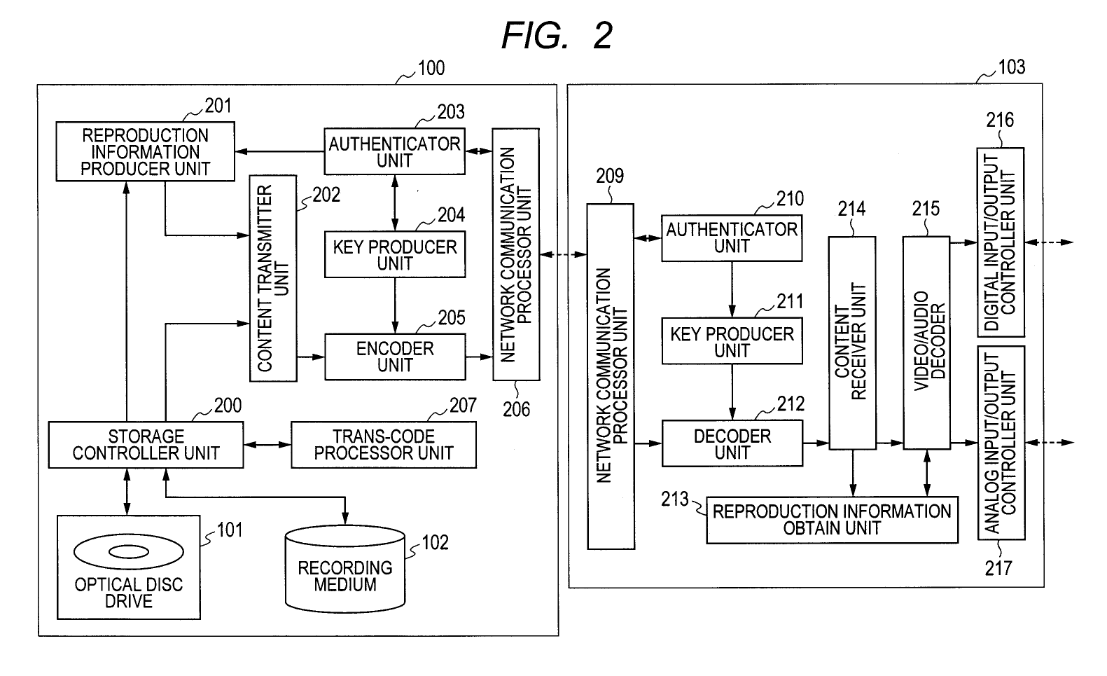

FIG. 2 is a block diagram for explaining the entire structures of the content distributing apparatus 100 and the content receiving apparatus 103, according to the present invention.

The content distributing apparatus 100 comprises the optical disc drive 101 and the built-in recording medium 102, and further comprises a storage controller unit 200, a reproduction information producer unit 201, a content transmitter unit 202, an authenticator unit 203, a key producer unit 204, an encoder unit 205, a network communication processor unit 206 and a trans-code processor unit 207.

The storage controller unit 200 is connected with the optical disc drive 101 and the recording medium 102, and reads out management information of video data and audio data, which are recorded on the optical disc loaded in the optical disc drive and on the recording medium 102. When the video/audio data is/are the content(s), the copyright of which should be protected, and are the data being encoded, such as, AACS, CPRM, CSS, etc., for example, then the storage controller unit 200 reads out the content(s) while decoding it/them.

Also, the storage controller unit 200 transfer the management information, which is read out, to the reproduction information producer unit 201, and also transfers the content(s) to the content transmitter unit 202. The management data includes information for identifying a kind of the video/audio data (for example, an IFO File), or information relating to a scene or a title of the video/audio data (for example, Clip Information File, Playlist file) therein.

The reproduction information producer unit 201 converts the management information, which is read out from the storage controller unit 200, into a format designated by DLNA or DTCP-IP. For example, for the content distributing apparatus 100, which will be mentioned later, to transmit a content list or other additional information, towards the content receiving apparatus 103, the information, such as, a content name, a format and/or date, etc., which are included in the management information mentioned above, is converted into the format in accordance with DLNA.

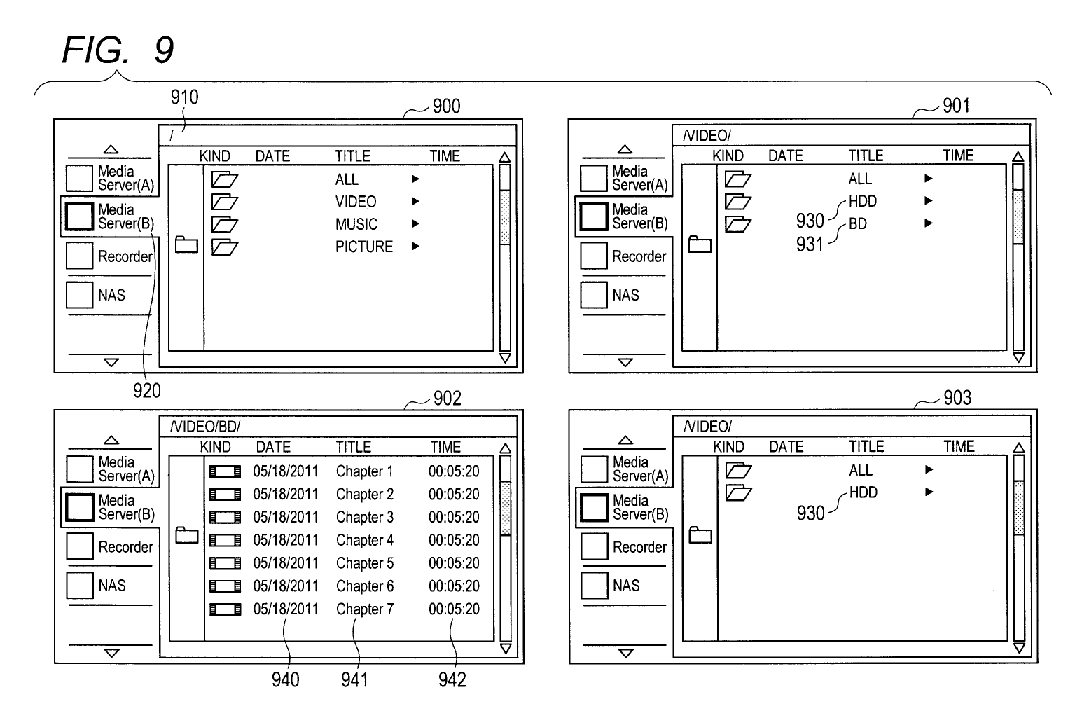

However, the reproduction information producer unit 201, not transmitting the file name recorded on the optical disc, as the content list, as it is, but converts that into the format, which can be displayed in the form of GUI (Graphic User Interface), as is shown in FIG. 9, to be outputted to the content reproducing apparatus. With doing this, for a user, it is possible to recognize a list name, with which she/he can easily find out the content list or the content(s), for each recoding medium; i.e., a usability of the user is improved.

Also, copy control information (“Copy never”, “Copy one generation, a number of times of enabling to copy, etc.) is also converted into the format in accordance with DLNA. Transmission of the content(s) with using DTCP-IP enables transmission of the data while protecting from the illegal copying thereof. With this, it is possible to transmit the content(s) recorded on the optical disc, which is loaded into the optical disc drive 101 to other terminal(s), but without being copied, illegally; i.e., the right of a copyright holder of the content(s) can be protect.

The content transmitter unit 202 transmits the video/audio data of the content(s), which is obtained from the storage controller unit 200, to the encoder unit 205, with the structure in accordance with DTCP-IP regulation. Depending on necessity, the management information transmitted from the reproduction information producer unit 201 mentioned above may be also transmitted to the encoder unit 205.

The authenticator unit 203 is connected with the reproduction information producer unit 201, the key producer unit 204 and the network communication processor unit 206. For transmitting the content(s), which is an object of the copyright protection, the authenticator unit 203 authenticates if the equipment is legally or formally authorized or not, mutually, between other AV equipment (i.e., the content receiving apparatus 103), upon a specific authentication protocol (e.g., in accordance with the DTCP-IP regulation, in the present embodiment), and shares a key to be used for coding/decoding of the content(s). Herein, the information necessary for that authentication protocol is obtained from the key producer unit 204.

The key producer unit 204 produces a key necessary for coding the content(s) upon basis of the key, which is shared with in the authenticator unit 203.

The encoder unit 205 is connected with the content transmitter unit 202, the key producer unit 204 and the network communication processor unit 206. The encoder unit 205 conducts a coding process of the content(s) with using the key information of the key producer unit 204.

The network communication processor unit 206, installing therein a communication protocol stack, such as, HTTP/RTP/TCP/UDP/IP, etc., grants a header for various kinds of protocols to the transmission data, and transmits the content(s) and other management information, depending the necessity thereof, to other equipments (i.e., the content receiving apparatus 103) connected with the network. It also sends/receives the data necessary for the authentication between the content receiving apparatus 103.

The trans-code processor unit 207 decodes the content data that is readout from the storage controller unit 200, and converts that into pixel value data of a digital video signal. Following thereto, it codes the pixel value data with using a coding method different from that of the original content(s). As the coding method are already known MPEG 2 (Motion Picture Experts Group 2) or H.264/MPEG 4 AVC (Advanced Video Coding), etc.

The content receiving apparatus 103 comprises a network communication processor unit 209, an authentication unit 210, a key producer unit 211, a decoder unit 212, a reproduction information obtain unit 213, a content receiver portion 214, a video/audio decoder 215, a digital input/output controller unit 216 and an analogue input/output controller unit 217.

The network communication processor unit 209 is connected with the content distributing apparatus 100 through the LAN. The network communication processor unit 209, installing therein a communication protocol stack, such as, HTTP/RTP/TCP/UDP/IP, etc., removes headers of various kinds of protocols, which are attached to the data received from the content distributing apparatus 100, and sends the content(s) and the other management information to the decoder unit 212. It also sends/receives the data necessary for authentication between the content distributing apparatus 100.

The authenticator unit 210 is connected with the network communication processor unit 209 and the key producer unit 211. The authenticator unit 210 authenticates if the equipment is legally authorized or not, mutually, between other AV equipment (i.e., the content distributing apparatus 100), upon a specific authentication protocol (e.g., in accordance with the DTCP-IP regulation, in the present embodiment), and shares a key to be used for coding/decoding of the content(s). Herein, the information necessary for that authentication protocol is obtained from the key producer unit 211.

The key producer unit 211 produces a key necessary for decoding the content(s) upon basis of the key, which is shared with in the authenticator unit 210.

The decoder unit 212 is connected with the key producer unit 211 and the content receiver unit 214. The decoder unit 212 conducts a decoding process of the content(s) with using the key information of the key producer unit 211.

The reproduction information obtain unit 213 receives reproduction information, which is produced in the reproduction information producer unit 201 of the content distributing apparatus 100, from the receiver unit 214, and reproduce/control data upon the reproduction information in cooperation with the video/audio decoder 215, which will be mentioned later.

The content receiver unit 214 takes out the reproduction information superposed, from the content(s) received from the decoder unit 212, and sends it to the reproduction information obtain unit 213. The content(s) itself/themselves is/are transmitted to the video/audio decoder 215.

The video/audio decoder 215 decodes the content(s), which is/are coded into various kinds of moving picture formats, such as, MPEG 2 or H.264/MPEG 4 AVC, and sends it/them to the digital input/output controller unit 216 or the analogue input/output controller unit 217.

The digital input/output controller unit 216 outputs digital data decoded in the video/audio decoder 215 to a display apparatus. For connection between the display apparatus is applied a cable/terminal for enabling to input/output the digital data, such as, HDMI or DVI (Digital Visual Interface), etc.

The analogue input/output controller unit 217 converts the digital data, which is decoded in the video/audio decoder 215, into analogue information through D/A conversion, and outputs it to the display apparatus. For connection between the display apparatus is applied a cable/terminal for enabling to input/output the analogue data, such as, a RCA terminal or a D terminal, etc.

On the optical disc loaded in the optical disc drive 101, it is assumed, are recorded the content(s), the information relating to that content(s), program(s) and so on, of movies and/or broadcasting programs, such as, DVD or BD, or programs distributed via the Internet, etc. As the built-in recording medium 102 may be applied various kinds of media, such as, a SD card, a HHD or a semiconductor memory, etc., other than DVD or BD, and on that are recorded the video/audio content(s), movie content(s), audio content(s), a still picture(s), a document(s) produced by PC, various kinds of programs, etc.

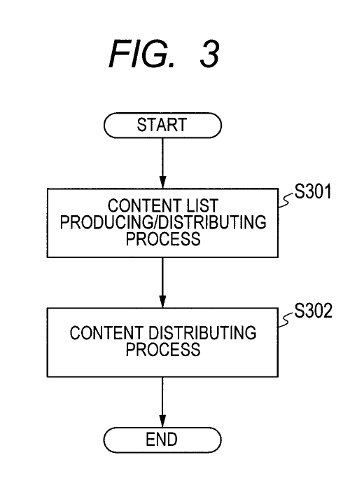

Herein, explanation will be given on an embodiment for showing the characteristics of the present invention, by referring to FIGS. 3 to 7. The explanation of the present embodiment will be made with using the content receiving apparatus 103, but the similar effect(s) can be obtained if applying other AV equipment.

FIG. 3 is a flowchart until when the content(s) accumulated within the content distributing apparatus 100 are distributed.

The content distributing apparatus 100, when receiving a content list obtaining request from the AV apparatus (the content receiving apparatus 103) connected with the network, via the network communication processor unit 206, collects the information relating to the content(s) recorded on the optical disc loaded in the optical disc drive 101 and the built-in recording medium 102 (for example, a title of the content, a recording format, a capacity, an obtain URL (Uniform Resource Locator) and/or a port number of the content, a flag indicating if being an object of the copyright protection or not, a port number for executing the authentication process, etc.), with using the storage controller unit 200, and produces the content list therein. The content list is transmitted to the content receiving apparatus 103, which is an origin of the request (step S301).

Following to the above, when receiving a content list distributing request from the content receiving apparatus 103 via the network, the content distributing apparatus 100 analyzes the content information included in that content list distributing request, so as to find out the content(s) requested from the optical disc loaded in the optical disc drive 101 and the built-in recording medium 102. Following to that, the content(s) requested are read out by means of the storage controller unit 200, and are transmitted by the content transmitter unit 202, and are transmitted to the content receiving apparatus 103, being an origin of the request (step S302).

Herein, in case where the content(s) requested be that, the copyright of which should be protected, a predetermined process for authentication is executed between the content receiving apparatus 103 with using the authenticator unit 203, and only when that authentication process is succeeded, the key information is shared between that content receiving apparatus 103. And, upon basis of the key information, which is shared in common, an encryption key is produced for coding the content(s), with using the key producer unit 204, and the content(s) read out by the storage controller unit 200 is/are coded by that encryption key with using the encoder unit 205, and are transmitted after being added thereto, a predetermined header (for example, the copy control information, such as, the “Copy never” or “No more copies”, etc., data length, information relating to the encryption key mentioned above, etc.), depending on necessity thereof.

About a timing for executing the authentication process mentioned above, the authentication process may be executed between that content distributing apparatus 100, before a content distributing request is issued to the content distributing apparatus 100 in the step S302, in particular, where desired content(s) is/are selected from among the content list received by the content receiving apparatus 103 and is/are determined to be the object of copyright protection, as a result of determination if it/they is/are or not, in the step S301.

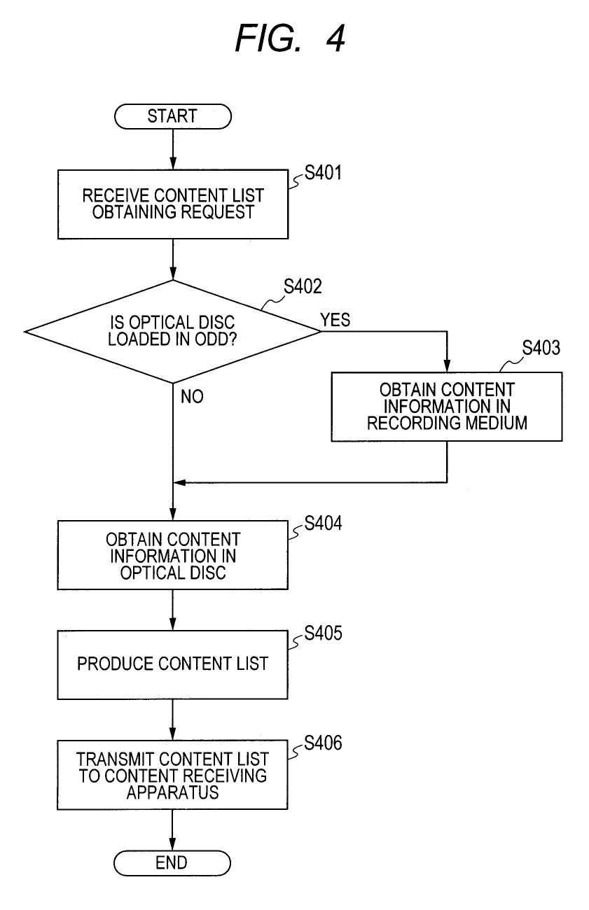

FIG. 4 is a flowchart for explaining the process for producing/distributing the content list in the step S301 shown in FIG. 3, in details thereof.

The content distributing apparatus 100 receives the content list obtaining request from the content receiving apparatus 103 through the network (step S401).

Next, a check is made if the optical disc is loaded or not into the optical disc drive 101 (step S402).

As a result of the step S402 mentioned above, if the optical disc is not loaded into the optical disc drive 101, the process moves into a step S404.

As a result of the step S402 mentioned above, if the optical disc is loaded into the optical disc drive 101, information is collected, relating to the content(s), which is/are recorded within the optical disc loaded into the optical disc drive 101 (step S403). The information relating to the content(s) mean(s) the information necessary for producing the content list, such as, a file name of the content, a video format of the content, a reproduction time of the content, etc.

Next, the information relating to the content(s) is collected, which is recorded within the built-in recording medium 102 (step S404).

Then, upon basis of the information collected in the steps S403 and S404 mentioned above, the content list is produced (step S405).

Finally, the content list is transmitted to the content receiving apparatus 103 (step S406).

In the step S403 mentioned above, the content information within the optical disc is collected, and the content list including the information of the content(s) within the optical disc therein is transmitted to the content receiving apparatus; thereby, for the user, it is possible to request/view the content(s) within the optical disc from the content receiving apparatus.

In the step S403 mentioned above, in particular, when an optical disc, including a first content for reproducing a moving picture, which is determined when an initial reproduction is executed, is provided within the optical disc drive apparatus mentioned above, then the content(s) other than the first content within that optical disc are not registered in the content list, when that optical disc is reproduced, initially, while the content(s) other than the first content within that optical disc are registered in the content list, in cases where that optical disc is not reproduced, initially.

The reproduction information producer unit 201 counts up a number of times of reproduction after that optical disc is provided in the optical disc drive apparatus mentioned above, and it memorizes that number therein.

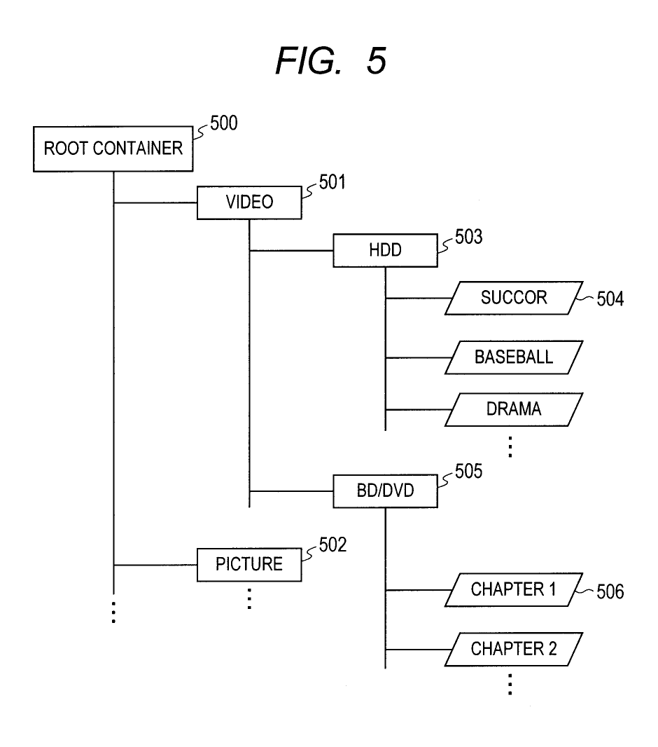

FIG. 5 shows an example of a content selection screen within the content receiving apparatus 103. The content receiving apparatus receives the content list from the content distributing apparatus, and produces the content selection screen, to be displayed to the user. On a lower layer of a root container is/are content(s), which is/are classified into content kinds, such as, video 501, pictures 502, etc. Further, on a lower layer of the video 501, for example, there are displayed the containers, which are classified by the recording medium within the content distributing apparatus, such as, HDD 503 and/or BD/DVD 505, etc. On a lower layer of the HDD 503 and/or BD/DVD 505 are displayed lines of characters for expressing the content(s) itself/themselves, such as, the content name and the file name, etc. For example, those are displayed to the user by a succor 504 and/or a chapter 1506. For the user, it is possible to request/view the content(s), by selecting the content(s) at her/his desire (e.g., the succor 50 or the chapter 1506, etc.) with using an input device of the content receiving apparatus.

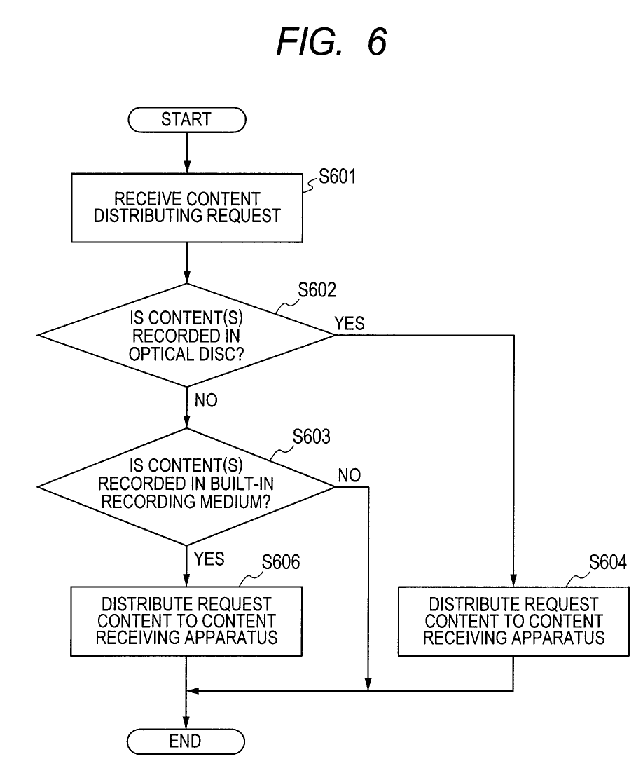

FIG. 6 is a flowchart for explaining the process for distributing content(s) in the step S302 shown in FIG. 3.

The content distributing apparatus 100 and the content receiving apparatus 103 execute the authentication process mentioned above, depending necessity thereof, and after sharing the key information necessary for coding/decoding of the content(s), the content distributing apparatus 100 receives the content distributing request from the content receiving apparatus 103 via the network (step S601).

The content distributing apparatus 100 checks if the content requested is one or not, being recorded on the optical disc, which is loaded into the optical disc drive 101 (step S602).

As a result of confirmation in the step S602 mentioned above, if not the content recorded on the optical disc, then the content is checked if it is one or not, being recorded on the built-in recording medium 102 (step S603). As a result thereof, if it is not the content, which is recorded on the built-in recording medium 102, the process is ended. If it is the content, which is recorded on the built-in recording medium 102, the process moves to a step S606. If it is the content, which is recorded in the optical disc, as a result of confirmation in the step S602 mentioned above, then the process moves to a step S604.

In the step S602, if the content request is that of the optical disc, then that content(s) requested is/are read out by means of the storage controller means 200, and is/are transmitted by the content transmitter unit 202, so as to be sent to the content receiving apparatus 103, which is the origin of the request, via the network communication processor unit 206 (step S606). Herein, the content transmitter unit 202 transmits a plural numbers of contents building up a main volume within the optical disc, in the order thereof, to the content receiving apparatus mentioned above.

In the step S603 mentioned above, if the content requested is within the built-in recording medium 102, that content requested is read out by the storage controller unit 200, and is transmitted by means of the content transmitter unit 202, so as to be sent to the contents receiving apparatus 103, which is the origin of the request, via the network communication processor unit 206 (step S606).

In the step S604 or the step S606, the requested content mentioned above, which is read out, is transmitted, after being transcoded or while being transcoded, into a format, being receivable by the content receiving apparatus 103 mentioned above, in the transcode processor unit 207, depending on necessity thereof.

Also, if the requested content is the one, the copyright of which should be protected, the requested content being read out or the requested content after/during being transcoded is encoded in the encoder unit 207, upon basis of the key information, which is shared in common within the step S601 mentioned above, in the format in accordance with the DTCP-IP regulation, and is transmitted.

From the above mentioned, according to the present embodiment, with the present invention, it is possible to transmit the content(s) recorded on the optical disc to the content receiving apparatus, including it/them within the content list thereof, when that optical disc is inserted into the content distributing apparatus 100.

Also, with this, for the content receiving apparatus, it is possible to receive the content(s) stored in the BD or the DVD, via the network, and therefore, for the user it is possible to view/listen the BD or the DVD even if she/he is at the place far from the content distributing apparatus.

Also, according to the present invention, by producing the content list for registering the main volume built up with plural numbers of the contents, which are recorded on the optical disc, as one (1) piece of content, in a list of content, and thereby transmitting the plural numbers of the contents building up the main volume within that optical disc, in the order thereof, it is possible for the content receiving apparatus 103 to receive all of the volumes of the contents, which are recorded on that optical disc, if only one of the contents is selected. With this, the user, who wishes to view/listen the content(s) with using the content receiving apparatus 103, can view/listen the content(s) without selection of plural numbers of chapters, which build up the main volume, for example, every occasion.

Also, within the content(s) recorded on the optical disc, if the content(s) of reproducing initially a predetermined moving picture is/are included therein, the user must view/listen the moving picture to be reproduced initially, every time when she/he tries to transmit the content(s) of the BD or the DVD via the network, simply; however, according to the present invention, with management of the number of times of reproducing from the time when that optical disc is loaded into the optical disc drive apparatus mentioned above, for the user, it is possible to view/listen the content(s) of the main volume within that optical disc, directly, but except when reproducing initially.

Also, when reproducing that optical disc, initially, since the moving picture to be reproduced initially is distributed, in the similar manner, it is possible to execute reproduction of the content, which a content holder intents, similar to the ordinary BD and DVD.

Herein, in the present embodiment, although the content list transmitting request or the content list distributing request is issued from the content receiving apparatus 103 to the content distributing apparatus 100, the content list transmitting request or the content list distributing request may be issued from the content distributing apparatus 100 to the content receiving apparatus 103. Also, for finding equipment lying on the network may be applied an existing method, such as, UPnP (Universal Plug and Play) etc., for example.

Also, the example of display of the content receiving apparatus shown in FIG. 5 is only one example, but it never restricts content of the display. Without departure from the gist of the present invention, the structure and the example of screen thereof may be changed.

Also, the flowcharts shown in FIGS. 3, 4 and 5 are shown only as examples, but never restrict the content(s) of the processes. The number of steps of the processes may be increased/decreased and/or the order of the processes, etc., may be altered, if not departing from the gist of the present invention.

Further, the structures of the home network, the content distributing apparatus, the content receiving apparatus, which are shown in FIGS. 1 and 2 of the embodiment 1, are only examples, but never restrict to those arrangements.

### Embodiment 2

The present embodiment is an example where the content receiving apparatus, i.e., a TV or a PC, etc., outputs the content(s) transmitted from a content distributing apparatus, to be viewed/listened.

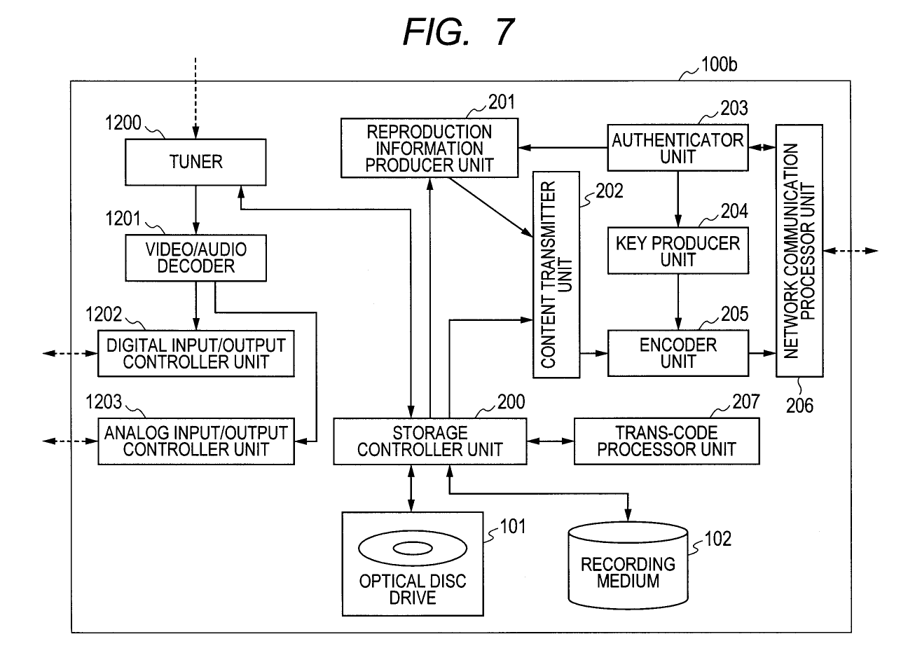

FIG. 7 shows the system configuration when expanding the content distributing apparatus 100 shown in FIG. 2, i.e., assuming a TV installing storage therein. The content distributing apparatus 100b comprises a tuner 1200, a video/audio recorder 1201, a digital input/output controller unit 1202 and an analogue input/output controller unit 1203, in addition to the constituent elements of the content distributing apparatus 100 shown in FIG. 2.

The tuner 1200 receives the digital broadcasting wavers, so as to decode into such a format that it can be inputted to the video/audio decoder 1201, and provides it to the video/audio decoder 1201 as an input. The format, which can be inputted to the video/audio decoder 1201, may be MPEG 2 or H.264, etc. Also, since being connected with the storage controller unit 200, it also can record the broadcast content(s) on the optical disc, which is loaded in the optical disc drive or the recording medium 102.

The video/audio decoder 1201 decodes the video/audio data received from the tuner 1200, and reproduces the video to the display apparatus, being connected through the digital input/output controller unit 1202 or an analogue input/output controller unit 1203. As the digital input/output controller unit 1202 may correspond to a cable/terminal, such as, HDMI or DVI, etc. Also, as the analogue input/output controller unit may correspond to a cable/terminal, such as, an RCA terminal or a D terminal, etc.

From the above, in the similar method to that of the embodiment 1, with the present embodiment, according to the present invention, in particular, when the optical disc is loaded in the content distributing apparatus 100, it is possible to transmit the content(s) recorded on that optical disc to the content receiving apparatus 103, including it/them within the content list.

Also, with this, the content receiving apparatus can receive the content(s) stored on BD and/or DVD, via the network, and therefore, for the user, it is possible to view/listen the BD or the DVD, if she/he is at the position far from the content distributing apparatus.

Also, according to the present invention, through reproducing the content list, registering the main volume therein, being built up with plural numbers of contents to be recorded on the optical disc, as a one (1) piece of content, and transmitting the plural numbers of contents building up the main volume within that optical disc, in the order thereof, then the content receiving apparatus 103 can receives all of the contents to be recorded on that optical disc of the main volume, if the user selects only one piece of content. With this, the user who wishes the content(s) with using the content receiving apparatus 103 can view/listen the content(s), without selecting one, every time, among plural numbers of chapters, which build up the main volume, for example.

Also, in case where there are contents for reproducing the moving picture, which is determined during when conducting the initial reproduction, within the contents recorded on the optical disc, and when the contents of the BD and the DVD are transmitted, simply, via the network, although the user must view/listen the moving picture of the initial reproduction, every time; however, according to the present invention, since management is made on the number of times or reproductions from the time when that optical disc is provided (or loaded) in the optical disc drive apparatus, then the user can view/listen the contents of the main volume within that optical disc, directly, but other than the time when conducting the initial reproduction.

Also, when conducting the initial reproduction of that optical disc, since the moving picture of the initial reproduction is distributed, similar to that of an ordinary BD player or an ordinary DVD player, it is possible to conduct reproduction of the contents intended in a content holder.

Further, as is shown in the present embodiment, the present invention can be applied even in the configuration combining the content distributing apparatus and the content receiving apparatus in one (1) body.

### Embodiment 3

The present embodiment is an example, in which the content receiving apparatus, such as, the TV or the PC, for example, provides the content(s) transmitted from the content distributing apparatus via the network, to be viewed/listened.

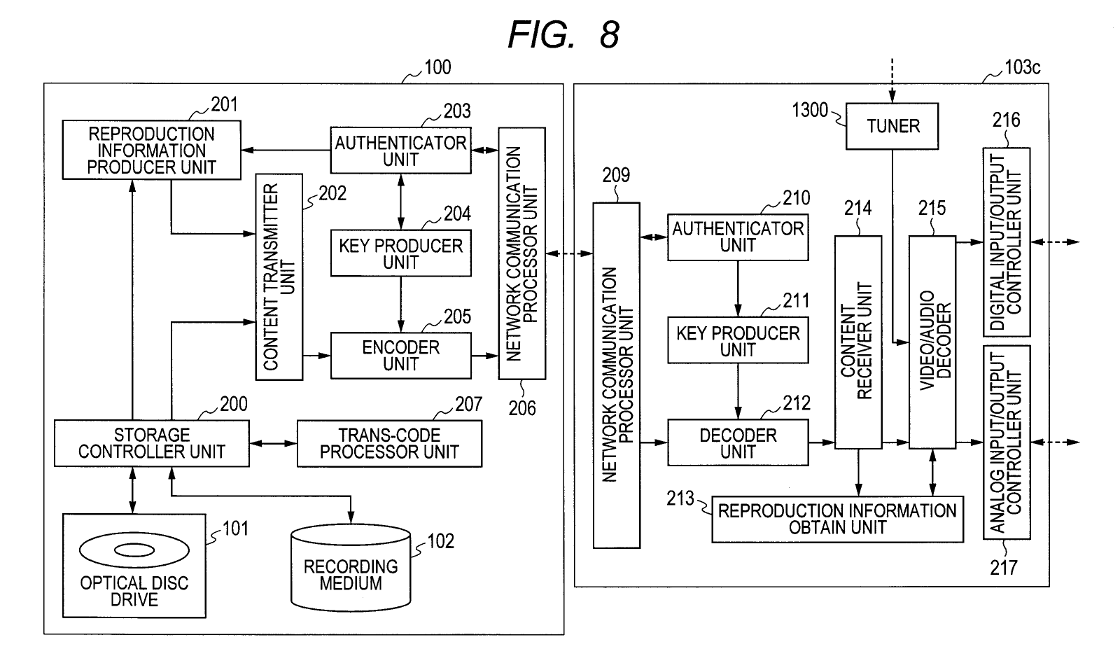

FIG. 8 shows the system configuration when assuming a TV having the tuner, through expanding the content receiving apparatus 103 shown in FIG. 2, in the similar method to that shown in FIG. 7. A content receiving apparatus 103c comprises a tuner 1300, in addition to the structure of the content receiving apparatus 103 shown in FIG. 2. The function of each constituent element is same to that shown in FIG. 7.

From the above, in the similar method to that of the embodiment 1, with the present embodiment, according to the present invention, in particular, when the optical disc is inserted into the content distributing apparatus 100, the content(s) recorded on that optical disc can be transmitted to the content receiving apparatus 103, including the content list therein.

Also, with this, the content receiving apparatus can receive the content(s) stored on the BD or the DVD, via the network, and therefore, for the user, it is possible to view/listen the BD or the DVD, if she/he is at the position far from the content distributing apparatus.

Also, according to the present invention, through reproducing the content list, registering the main volume therein, being built up with plural numbers of contents to be recorded on the optical disc, as a one (1) piece of content, and transmitting the plural numbers of contents building up the main volume within that optical disc, in the order thereof, then the content receiving apparatus 103 can receives all of the contents to be recorded on that optical disc of the main volume, if the user selects only one piece of content. With this, the user who wishes the contents with using the content receiving apparatus 103 can view/listen the contents, without selecting one, every time, among plural numbers of chapters, which build up the main volume, for example.

Also, in case where there are contents for reproducing the moving picture, which is determined during when conducting the initial reproduction, within the contents recorded on the optical disc, and when the contents of the BD and the DVD are transmitted, simply, via the network, although the user must view/listen the moving picture of the initial reproduction, every time; however, according to the present invention, since management is made on the number of times or reproductions from the time when that optical disc is provided (or loaded) in the optical disc drive apparatus, then the user can view/listen the contents of the main volume within that optical disc, directly, but other than the time when conducting the initial reproduction.

Also, when conducting the initial reproduction of that optical disc, since the moving picture of the initial reproduction is distributed, similar to that of an ordinary BD player or an ordinary DVD player, it is possible to conduct reproduction of the contents intended in a content holder.

Further, as is shown in the present embodiment, the present invention can be applied even into the configuration of the content receiving apparatus having the tuner therein.

However, the present invention should not be restricted to the embodiments mentioned in the above, but may includes therein various variations thereof. For example, the embodiments mentioned above are explained in details thereof, for the purpose of easy understanding thereof, and therefore, the present invention should not be limited to that having all of the constituent elements thereof. Also, a part of the constituent elements of a certain embodiment can be substituted with the constituent element of the other embodiment(s), or the constituent element of other embodiment(s) may be added to a part of the constituent element of a certain embodiment. Also, regarding a part of the constituent elements of each embodiment, it may be added/deleted/substituted with other constituent element(s).

Also, with each constituent element, function, processing unit, processing means, etc., mentioned above, a part or all thereof may be achieved with hardware, such as, by designing it with an integrated circuit, etc. Also, each constituent element or function, etc., mentioned above may be achieved in the form of software, wherein a processor interprets programs for achieving the respective functions and executes them. The information of the programs, tables or files, etc., for achieving each function may be located in a recording device, such as, a memory, a hard disc, a SSD (Solid State Drive), etc., or a recoding medium, such as, an IC card, a SD card, a DVD, etc.

Also, control lines and/or information lines are shown, which can be considered to be necessary for the explanation, but all of the control lines and the information lines, which are necessary for a product, are not shown, necessarily. Actually, it can be considered that almost of all constituent elements are connected, mutually, with each other.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A distributing apparatus, for a content list and content(s), installing an optical disc drive apparatus and/or a recording medium other than an optical disc, comprising:
a communication processor unit, which is configured to execute transmission of data between a content receiving apparatus to be connected with, through a network;
a content list producer unit, which is configured to produce a content list for content(s) existing within the optical disc and the recording medium other than the optical disc, in form of a list for each recording medium, when said optical disc is loaded in said optical disc drive apparatus, while to produce a list for contents existing within the recording medium other than the optical disc, as a content list, when the optical disc is not loaded within said optical disc drive apparatus, in response to a content list obtaining request transmitted from said content receiving apparatus;
a content list transmitter unit, which is configured to transmit the list produced by said content list producer unit;
a content transmitter unit, which is configured to search out corresponding content(s) from, within the optical disc loaded in said optical disc drive apparatus and the recording medium other than the optical disc, and to transmit it/them to said content receiving apparatus, in response to a content distributing request transmitted from said content receiving apparatus;
an authenticator unit, which is configured to authenticate to be equipment authorized legally, mutually, between said content receiving apparatus;
a key producer unit, which is configured to produce key information necessary for encoding the content(s) to be transmitted by said content transmitter unit; and
an encoder unit, which is configured to encode the content(s) with using the key information in said key producer unit.

2. The distributing apparatus, for a content list and content(s), as described in the claim 1, further comprising:
a content list producer unit, which is configured to register a main volume, being made up with plural numbers of contents within said optical disc, into the list of content(s), as one (1) content, when the optical disc is loaded in said optical disc drive apparatus; and
a content transmitter unit, which is configured to transmit the plural numbers of contents making up the main volume within said optical disc, in order thereof, to said content receiving apparatus.

3. The distributing apparatus, for a content list and content(s), as described in the claim 1, further comprising:
a content list producer unit, which is configured not to register content(s) other than first content(s) within said optical disc into the list of content(s), when conducting an initial reproduction of said optical disc, but to register the content(s) other than first content(s) within said optical disc into the list of content(s), other than when conducting an initial reproduction of said optical disc, in case where an optical disc is loaded in said optical disc drive apparatus, including the first content(s) for reproducing a moving picture, which is determined in time when conducting an initial reproduction; and
a reproduction number of times management unit, which is configured to manage a number of times of reproducing from time when said optical disc is loaded in said optical disc drive apparatus.

4. A method for a distributing apparatus of a content list and content(s), installing an optical disc drive apparatus and a recording medium other than an optical disc therein, to transmit the content list and the content(s) to a content receiving apparatus to be connected with, through a network in accordance with DLNA, comprising the followings steps of:
a content list producing step, for producing a content list for content(s) existing within the optical disc and the recording medium other than the optical disc, in form of a list for each recording medium, when said optical disc is loaded in said optical disc drive apparatus, while producing a list for contents existing within the recording medium other than the optical disc, as a content list, when the optical disc is not loaded within said optical disc drive apparatus, in response to a content list obtaining request transmitted from said content receiving apparatus;
a content list transmitting step for transmitting the list produced by said content list producing step;
a content transmitting step, for searching out corresponding content(s) from, within the optical disc loaded in said optical disc drive apparatus and the recording medium other than the optical disc, and for transmitting it/them to said content receiving apparatus, in response to a content distributing request transmitted from said content receiving apparatus;
an authenticating step, for authenticating to be equipment authorized legally, mutually, between said content receiving apparatus;
a key producing step, for producing key information necessary for encoding the content(s) to be transmitted in said content transmitting step; and
an encoding step, for encoding the content(s) with using the key information produced in said key producing step.

5. The transmitting method for the content list and the content(s), as described in the claim 4, further comprising the following steps of:
a content list producing step, for registering a main volume, being made up with plural numbers of contents within said optical disc, into the list of content(s), as one (1) content, when the optical disc is loaded in said optical disc drive apparatus; and
a content transmitting step for transmitting the plural numbers of contents making up the main volume within said optical disc, in order thereof, to said content receiving apparatus.

6. The transmitting method for the content list and the content(s), as described in the claim 4, further comprising the following steps of:
a content list producing step, not for registering content(s) other than first content(s) within said optical disc into the list of content(s), when conducting an initial reproduction of said optical disc, but registering the content(s) other than first content(s) within said optical disc into the list of content(s), other than when conducting an initial reproduction of said optical disc, in case where an optical disc is loaded in said optical disc drive apparatus, including the first content(s) for reproducing a moving picture, which is determined in time when conducting an initial reproduction; and
a reproduction number of times managing step, for managing a number of times of reproducing from time when said optical disc is loaded in said optical disc drive apparatus.
